(19) United States
(12) Patent Application Publication
(10) Pub. No.: US 2019/0367078 A1
(43) Pub. Date: Dec. 5, 2019

(54) STEERING CONTROL APPARATUS

(71) Applicant: JTEKT CORPORATION, Osaka (JP)

(72) Inventors: Koji ANRAKU, Okazaki-shi (JP); Isao NAMIKAWA, Okazaki-shi (JP); Yusuke KAKIMOTO, Okazaki-shi (JP)

(73) Assignee: JTEKT CORPORATION, Osaka (JP)

(21) Appl. No.: 16/422,105

(22) Filed: May 24, 2019

(30) Foreign Application Priority Data
May 30, 2018 (JP) 2018-103467

(51) Int. Cl. B62D 5/04; B62D 6/00

(52) U.S. Cl. CPC B62D 5/0463; B62D 5/0409; B62D 6/08; B62D 6/008; B62D 6/006

(57) ABSTRACT

A control apparatus controls a steering reaction motor. The control apparatus includes an ideal axial force calculation circuit, an estimated axial force calculation circuit, an imaginary rack end axial force calculation circuit, an axial force allocation calculation circuit and a maximum value selection circuit. The calculation circuits calculate an ideal axial force based on a target pinion angle, an estimated axial force based on a current value of a steering operation motor, an imaginary rack end axial force for imaginarily limiting an operation range of a steering wheel, a mixed axial force obtained by allocating the ideal axial force and the estimated axial force at predetermined allocation ratios. The maximum value selection circuit selects the mixed axial force or the imaginary rack end axial force having a larger absolute value as an axial force to be reflected in the command value.

### INCORPORATION BY REFERENCE

The disclosure of Japanese Patent Application No. 2018-103467 filed on May 30, 2018 including the specification, drawings and abstract, is incorporated herein by reference in its entirety.

### BACKGROUND OF THE INVENTION

### 1. Field of the Invention

The present invention relates to a steering control apparatus.

### 2. Description of the Related Art

Hitherto, there is known a so-called steer-by-wire type steering system that achieves separation in power transmission between a steering wheel and steered wheels. This steering system includes a reaction motor and a steering operation motor. The reaction motor is a source of a steering reaction force to be applied to a steering shaft. The steering operation motor is a source of a steering operation force for turning the steered wheels. When a vehicle is traveling, a control apparatus of the steering system generates the steering reaction force through the reaction motor, and turns the steered wheels through the steering operation motor.

It is not likely that a road reaction force applied to the steered wheels is transmitted to the steering wheel because the steer-by-wire type steering system achieves the separation in the power transmission between the steering wheel and the steered wheels. Thus, it is difficult for the driver to grasp a road condition as the steering reaction force (tactile feedback) that may be felt by the hands through the steering wheel.

For example, a control apparatus described in Japanese Patent Application Publication No. 2017-165219 (JP 2017-165219 A) calculates an ideal axial force and a road axial force. The ideal axial force is an ideal rack axial force that is based on a target steered angle. The road axial force is an estimated value of a rack axial force that is based on a current value of the steering operation motor. The control apparatus sums up the ideal axial force and the road axial force at predetermined allocation ratios, and controls the reaction motor by using a base reaction force that is based on the summed-up axial forces. The road axial force reflects the road condition (road information), and therefore the steering reaction force generated by the reaction motor also reflects the road condition. Thus, the driver can grasp the road condition as the steering reaction force.

The control apparatus calculates a limiting reaction force for imaginarily limiting an operation range of the steering wheel. The control apparatus selects a larger one of a target steering angle and the target steered angle. When the selected target steering angle or the selected target steered angle reaches a threshold, the control apparatus generates the limiting reaction force, and steeply increases the limiting reaction force. The threshold is set from the viewpoint of steeply increasing the steering reaction force both immediately before a rack shaft configured to turn the steered wheels reaches a limit position of its physically movable range and immediately before the steering wheel reaches a limit position of an operation range defined depending on a spiral cable.

The control apparatus calculates a final reaction force by summing up the base reaction force and the limiting reaction force, and controls the reaction motor by using the final reaction force. When the steering reaction force steeply increases after the target steering angle or the target steered angle reaches the threshold, it is difficult for the driver to operate the steering wheel in a direction in which the absolute value of the steering angle increases. This control can imaginarily create the operation range of the steering wheel and furthermore the movable range of the rack shaft.

The control apparatus of JP 2017-165219 A has the following concerns. That is, when the limiting reaction force is calculated, the control apparatus calculates the final reaction force to be used for controlling the reaction motor by adding the limiting reaction force to the base reaction force. Since the limiting reaction force is added to the base reaction force, an excessive steering reaction force may be applied to the driver. This phenomenon is likely to occur, for example, when the limiting reaction force is added in a state in which the allocation ratio of the road axial force to the base reaction force is larger, that is, in a state in which the road axial force is dominant as in a case where the vehicle turns with a large radius at a low speed.

### SUMMARY OF THE INVENTION

It is one object of the present invention to provide a steering control apparatus in which a more appropriate steering reaction force can be applied to a driver.

One aspect of the present invention relates to a steering control apparatus configured to control a motor based on a command value calculated depending on a steering condition. The motor is configured to generate a driving force to be applied to a steering mechanism of a vehicle including a steering operation shaft configured to turn a steered wheel. The steering control apparatus includes a steering range axial force calculation circuit, a limiting axial force calculation circuit, and a selection circuit. The steering range axial force calculation circuit is configured to calculate a steering range axial force based on a condition amount of the vehicle. The steering range axial force is an axial force applied to the steering operation shaft when a steering wheel is operated within a defined operation range. The limiting axial force calculation circuit is configured to calculate a limiting axial force as an axial force of the steering operation shaft based on a condition amount of the vehicle in which the steering condition or a steered condition of the steered wheel is reflected, so as to imaginarily limit an operation of the steering wheel. The selection circuit is configured to select an axial force having a largest absolute value out of the steering range axial force and the limiting axial force as an axial force to be reflected in the command value.

According to this configuration, when the selection circuit selects, as the axial force to be reflected in the command value, the steering range axial force calculated based on the condition amount of the vehicle, the steering range axial force is reflected in the command value. Therefore, the motor generates a driving force that reflects the condition of the vehicle. Thus, the driver can acquire tactile feedback via the steering wheel in response to the condition of the vehicle. When the selection circuit selects, as the axial force to be reflected in the command value, the limiting axial force for imaginarily limiting the operation of the steering wheel, the limiting axial force is reflected in the command value. Therefore, the driver acquires a feeling of abutment as the steering reaction force. Thus, the driver's operation for the steering wheel can be limited imaginarily. An axial force having a largest absolute value out of the steering range axial force and the limiting axial force is selected as the axial force to be reflected in the command value. Therefore, it is possible to reduce the occurrence of a case where an excessive axial force is reflected in the command value unlike a case where both the steering range axial force and the limiting axial force are reflected in the command value. Thus, a more appropriate steering reaction force can be applied to the driver. Further, application of an excessive steering reaction force to the driver is suppressed. Thus, it is possible to reduce driver's discomfort due to the application of an excessive steering reaction force.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a configuration diagram of a steer-by-wire type steering system on which a steering control apparatus according to a first embodiment is mounted;

FIG. 2 is a control block diagram of a control apparatus according to the first embodiment;

FIG. 3 is a control block diagram of a target steering angle calculation circuit according to the first embodiment;

FIG. 4 is a control block diagram of a vehicle model according to the first embodiment;

FIG. 5 is a graph illustrating a map that defines a relationship between a target pinion angle and an ideal axial force according to the first embodiment;

FIG. 6 is a graph illustrating a map that defines a relationship between an imaginary rack end angle (target steering angle or target pinion angle) and an imaginary rack end axial force according to the first embodiment;

FIG. 7 is a graph illustrating a relationship between the target steering angle and a final axial force according to the first embodiment;

FIG. 8 is a control block diagram of a vehicle model of a steering control apparatus according to a second embodiment;

FIG. 9 is a control block diagram of a first limiting axial force calculation circuit according to the second embodiment; and

FIG. 10 is a control block diagram of a second limiting axial force calculation circuit according to the second embodiment.

### DETAILED DESCRIPTION OF EMBODIMENTS

Description is given below of a steering control apparatus according to a first embodiment of the present invention, which is applied to a steer-by-wire type steering system.

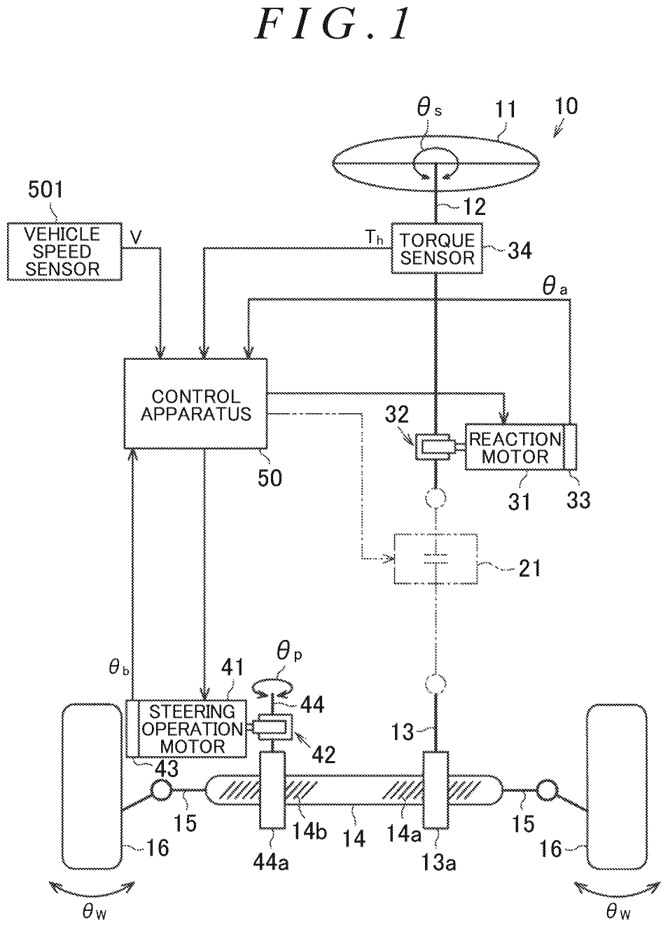

As illustrated in FIG. 1, a steering system 10 for a vehicle includes a steering shaft 12 coupled to a steering wheel 11. The steering system 10 further includes a steering operation shaft 14 extending along a vehicle width direction (lateral direction in FIG. 1). Right and left steered wheels 16 and 16 are coupled to both ends of the steering operation shaft 14 via tie rods 15 and 15, respectively. The steering operation shaft 14 performs linear motion to change a steered angle θ_{w} of each of the steered wheels 16 and 16. The steering shaft 12 and the steering operation shaft 14 constitute a steering mechanism.

<Structure for Generating Steering Reaction Force: Reaction Unit>

The steering system 10 includes a reaction motor 31, a speed reducing mechanism 32, a rotation angle sensor 33, and a torque sensor 34 as a structure for generating a steering reaction force. The steering reaction force is a force (torque) to be applied in a direction opposite to a direction of a driver's operation for the steering wheel 11. By applying the steering reaction force to the steering wheel 11, the driver can acquire appropriate tactile feedback.

The reaction motor 31 is a source of the steering reaction force. For example, a three-phase (U, V, W) brushless motor is employed as the reaction motor 31. The reaction motor 31 (to be exact, its rotation shaft) is coupled to the steering shaft 12 via the speed reducing mechanism 32. A torque of the reaction motor 31 is applied to the steering shaft 12 as the steering reaction force.

The rotation angle sensor 33 is provided on the reaction motor 31. The rotation angle sensor 33 detects a rotation angle θₐ of the reaction motor 31. The rotation angle θₐ of the reaction motor 31 is used for calculating a steering angle θₛ. The reaction motor 31 and the steering shaft 12 operate in association with each other via the speed reducing mechanism 32. Therefore, the rotation angle θₐ of the reaction motor 31 is correlated to the steering angle θₛ that is a rotation angle of the steering shaft 12 and furthermore a rotation angle of the steering wheel 11.

Thus, the steering angle θₛ can be determined based on the rotation angle θₐ of the reaction motor 31.

The torque sensor 34 detects a steering torque Tₕ applied to the steering shaft 12 through a rotational operation for the steering wheel 11. The torque sensor 34 is provided at a part of the steering shaft 12 that is located on the steering wheel 11 side with respect to the speed reducing mechanism 32.

<Structure for Generating Steering Operation Force: Steering Operation Unit>

The steering system 10 includes a steering operation motor 41, a speed reducing mechanism 42, and a rotation angle sensor 43 as a structure for generating a steering operation force that is power for turning the steered wheels 16 and 16.

The steering operation motor 41 is a source of the steering operation force. For example, a three-phase brushless motor is employed as the steering operation motor 41. The steering operation motor 41 (to be exact, its rotation shaft) is coupled to a pinion shaft 44 via the speed reducing mechanism 42. Pinion teeth 44a of the pinion shaft 44 mesh with rack teeth 14b of the steering operation shaft 14. A torque of the steering operation motor 41 is applied to the steering operation shaft 14 via the pinion shaft 44 as the steering operation force. In response to rotation of the steering operation motor 41, the steering operation shaft 14 moves along the vehicle width direction (lateral direction in FIG. 1).

The rotation angle sensor 43 is provided on the steering operation motor 41. The rotation angle sensor 43 detects a rotation angle θ_{b} of the steering operation motor 41. The steering system 10 includes a pinion shaft 13. The pinion shaft 13 is provided so as to intersect the steering operation shaft 14. Pinion teeth 13a of the pinion shaft 13 mesh with rack teeth 14a of the steering operation shaft 14. The pinion shaft 13 is provided in order to support the steering operation shaft 14 inside a housing (not illustrated) in cooperation with the pinion shaft 44. That is, a support mechanism (not illustrated) provided in the steering system 10 supports the steering operation shaft 14 so as to be movable along its axial direction, and presses the steering operation shaft 14 toward the pinion shafts 13 and 44. Thus, the steering operation shaft 14 is supported inside the housing. Another support mechanism that supports the steering operation shaft 14 inside the housing without using the pinion shaft 13 may be provided instead.

The steering system 10 includes a control apparatus 50. The control apparatus 50 controls the reaction motor 31 and the steering operation motor 41 based on detection results from various sensors. As the sensors, a vehicle speed sensor 501 is provided in addition to the rotation angle sensor 33, the torque sensor 34, and the rotation angle sensor 43 described above. The vehicle speed sensor 501 is provided on the vehicle to detect a vehicle speed V that is a traveling speed of the vehicle

The control apparatus 50 executes reaction control for generating a steering reaction force based on the steering torque Tₕ through drive control for the reaction motor 31. The control apparatus 50 calculates a target steering reaction force based on the steering torque Tₕ and the vehicle speed V, and calculates a target steering angle of the steering wheel 11 based on the calculated target steering reaction force, the steering torque Tₕ, and the vehicle speed V. The control apparatus 50 calculates a steering angle correction amount through feedback control of the steering angle θₛ, which is executed so that the actual steering angle θₛ follows the target steering angle, and calculates a steering reaction force command value by adding the calculated steering angle correction amount to the target steering reaction force. The control apparatus 50 supplies, to the reaction motor 31, a current necessary to generate a steering reaction force based on the steering reaction force command value.

The control apparatus 50 executes steering operation control for turning the steered wheels 16 and 16 depending on a steering condition through drive control for the steering operation motor 41. The control apparatus 50 calculates a pinion angle θₚ that is an actual rotation angle of the pinion shaft 44 based on the rotation angle θ_{b} of the steering operation motor 41 that is detected through the rotation angle sensor 43. The pinion angle θₚ is a value that reflects the steered angle θ_{w} of each of the steered wheels 16 and 16. The control apparatus 50 calculates a target pinion angle by using the target steering angle described above. Then, the control apparatus 50 determines a deviation between the target pinion angle and the actual pinion angle θₚ, and controls power supply to the steering operation motor 41 so as to eliminate the deviation.

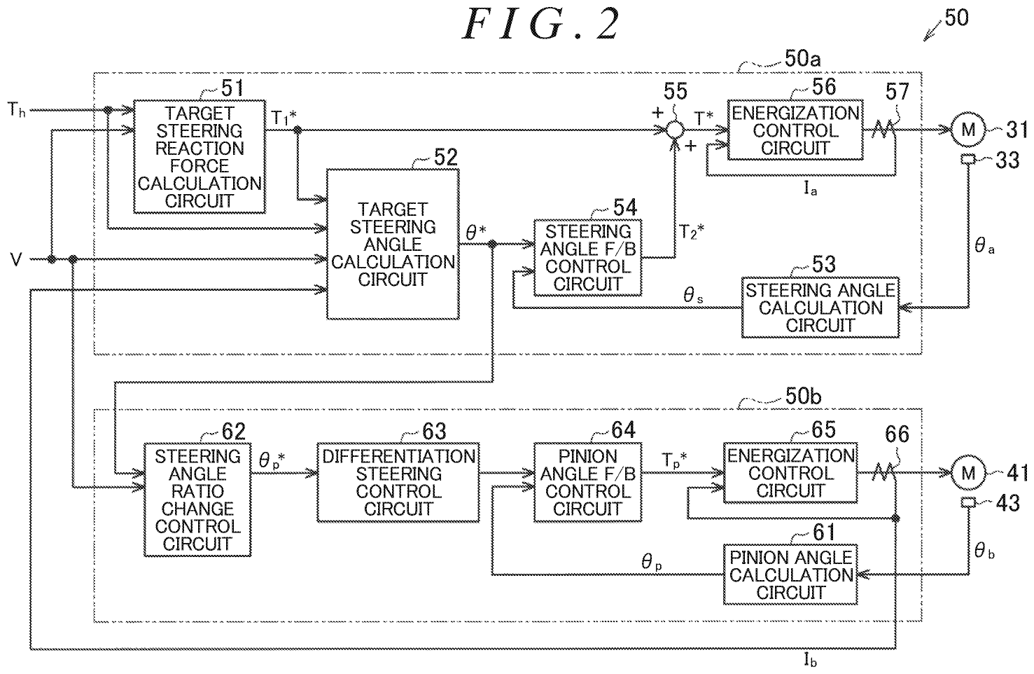

Next, a detailed configuration of the control apparatus 50 is described. As illustrated in FIG. 2, the control apparatus 50 includes a reaction control circuit 50a configured to execute the reaction control, and a steering operation control circuit 50b configured to execute the steering operation control.

<Reaction Control Circuit>

The reaction control circuit 50a includes a target steering reaction force calculation circuit 51, a target steering angle calculation circuit 52, a steering angle calculation circuit 53, a steering angle feedback control circuit 54, an adder 55, and an energization control circuit 56.

The target steering reaction force calculation circuit 51 calculates a target steering reaction force T₁* based on the steering torque Tₕ and the vehicle speed V. The target steering reaction force calculation circuit 51 calculates a target steering reaction force T₁* having a larger value (absolute value) as the absolute value of the steering torque Tₕ increases and as the vehicle speed V decreases.

The target steering angle calculation circuit 52 calculates a target steering angle θ* of the steering wheel 11 by using the target steering reaction force T₁*, the steering torque Tₕ, and the vehicle speed V. The target steering angle calculation circuit 52 has an ideal model that defines an ideal steering angle based on an input torque, which is the total sum of the target steering reaction force T₁* and the steering torque Tₕ. The ideal model is obtained by modeling a steering angle corresponding to an ideal steered angle based on the input torque through an experiment or the like in advance on the premise of a steering system in which the steering wheel 11 and the steered wheels 16 and 16 are mechanically coupled together. The target steering angle calculation circuit 52 determines the input torque by adding the target steering reaction force T₁* and the steering torque Tₕ together, and calculates the target steering angle θ* from the input torque based on the ideal model.

The steering angle calculation circuit 53 calculates the actual steering angle θₛ of the steering wheel 11 based on the rotation angle θₐ of the reaction motor 31 that is detected through the rotation angle sensor 33. The steering angle feedback control circuit 54 calculates a steering angle correction amount T₂* through feedback control of the steering angle θₛ so that the actual steering angle θₛ follows the target steering angle θ*. The adder 55 calculates a steering reaction force command value T* by adding the steering angle correction amount T₂* to the target steering reaction force T₁*.

The energization control circuit 56 supplies electric power to the reaction motor 31 based on the steering reaction force command value T*. Specifically, the energization control circuit 56 calculates a current command value for the reaction motor 31 based on the steering reaction force command value T*. The energization control circuit 56 detects an actual current value Iₐ generated in a power supply path to the reaction motor 31 through a current sensor 57 provided in the power supply path. The current value Iₐ is a value of an actual current supplied to the reaction motor 31. Then, the energization control circuit 56 determines a deviation between the current command value and the actual current value Iₐ, and controls power supply to the reaction motor 31 so as to eliminate the deviation (feedback control of the current value Iₐ). Thus, the reaction motor 31 generates a torque based on the steering reaction force command value T*. The driver can acquire appropriate tactile feedback in response to a road reaction force.

<Steering Operation Control Circuit>

As illustrated in FIG. 2, the steering operation control circuit 50b includes a pinion angle calculation circuit 61, a steering angle ratio change control circuit 62, a differentiation steering control circuit 63, a pinion angle feedback control circuit 64, and an energization control circuit 65.

The pinion angle calculation circuit 61 calculates the pinion angle θₚ that is an actual rotation angle of the pinion shaft 44 based on the rotation angle θ_{b} of the steering operation motor 41 that is detected through the rotation angle sensor 43. As described above, the steering operation motor 41 and the pinion shaft 44 operate in association with each other via the speed reducing mechanism 42. Therefore, there is a correlation between the rotation angle θ_{b} of the steering operation motor 41 and the pinion angle θₚ. By using the correlation, the pinion angle θₚ can be determined from the rotation angle θ_{b} of the steering operation motor 41. As described above, the pinion shaft 44 meshes with the steering operation shaft 14. Therefore, there is also a correlation between the pinion angle θₚ and the movement amount of the steering operation shaft 14. That is, the pinion angle θₚ is a value that reflects the steered angle θ_{w} of each of the steered wheels 16 and 16.

The steering angle ratio change control circuit 62 sets a steering angle ratio, which is the ratio of the steered angle θ_{w} to the steering angle θₛ, based on a traveling condition of the vehicle (for example, the vehicle speed V), and calculates a target pinion angle based on the set steering angle ratio. The steering angle ratio change control circuit 62 calculates a target pinion angle θₚ* so that the steered angle θ_{w} increases relative to the steering angle θₛ as the vehicle speed V decreases or that the steered angle θ_{w} decreases relative to the steering angle θₛ as the vehicle speed V increases. In order to achieve the steering angle ratio to be set based on the traveling condition of the vehicle, the steering angle ratio change control circuit 62 calculates a correction angle for the target steering angle θ*, and adds the calculated correction angle to the target steering angle θ*, thereby calculating the target pinion angle θₚ* based on the steering angle ratio.

The differentiation steering control circuit 63 calculates a change speed of the target pinion angle θₚ* (steered speed) by differentiating the target pinion angle θₚ*. The differentiation steering control circuit 63 calculates a correction angle for the target pinion angle θₚ* by multiplying the change speed of the target pinion angle θₚ* by a gain. The differentiation steering control circuit 63 calculates a final target pinion angle θₚ* by adding the correction angle to the target pinion angle θₚ*. A delay in the steering operation is adjusted by advancing the phase of the target pinion angle θₚ* calculated by the steering angle ratio change control circuit 62. That is, a steering operation response is secured based on the steered speed.

The pinion angle feedback control circuit 64 calculates a pinion angle command value Tₚ* through feedback control (proportional-integral-derivative (PID) control) of the pinion angle θₚ so that the actual pinion angle θₚ follows the final target pinion angle θₚ* calculated by the differentiation steering control circuit 63.

The energization control circuit 65 supplies electric power to the steering operation motor 41 based on the pinion angle command value Tₚ*. Specifically, the energization control circuit 65 calculates a current command value for the steering operation motor 41 based on the pinion angle command value Tₚ*. The energization control circuit 65 detects an actual current value I_{b} generated in a power supply path to the steering operation motor 41 through a current sensor 66 provided in the power supply path. The current value I_{b} is a value of an actual current supplied to the steering operation motor 41. Then, the energization control circuit 65 determines a deviation between the current command value and the actual current value I_{b}, and controls power supply to the steering operation motor 41 so as to eliminate the deviation (feedback control of the current value I_{b}). Thus, the steering operation motor 41 rotates by an angle that is based on the pinion angle command value Tₚ*.

<Target Steering Angle Calculation Circuit>

Next, the target steering angle calculation circuit 52 is described in detail. As described above, the target steering angle calculation circuit 52 calculates the target steering angle θ* based on the ideal model from the input torque, which is the total sum of the target steering reaction force T₁* and the steering torque Tₕ. The ideal model is a model using the fact that an input torque Tᵢₙ* that is a torque applied to the steering shaft 12 is represented by Expression (1).

Tᵢₙ*=Jθ*^{″}+Cθ*^{′}+Kθ* (1)

In Expression (1), “J” represents a moment of inertia of each of the steering wheel 11 and the steering shaft 12, “C” represents a coefficient of viscosity (coefficient of friction) corresponding to, for example, friction of the steering operation shaft 14 against the housing, and “K” represents a spring modulus assuming the steering wheel 11 and the steering shaft 12 as springs.

As understood from Expression (1), the input torque Tᵢₙ* is obtained by adding together a value obtained by multiplying a second-order time derivative θ*^{″} of the target steering angle θ* by the moment of inertia J, a value obtained by multiplying a first-order time derivative θ*^{′} of the target steering angle θ* by the coefficient of viscosity C, and a value obtained by multiplying the target steering angle θ* by the spring modulus K. The target steering angle calculation circuit 52 calculates the target steering angle θ* in accordance with the ideal model based on Expression (1).

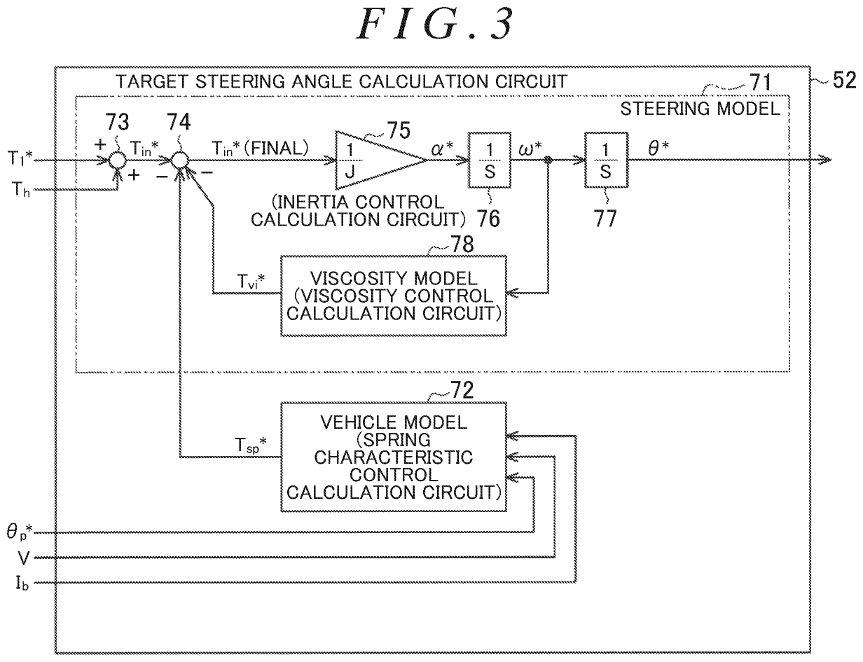

As illustrated in FIG. 3, the ideal model that is based on Expression (1) is divided into a steering model 71 and a vehicle model 72. The steering model 71 is tuned based on characteristics of the components of the steering system 10, such as the steering shaft 12 and the reaction motor 31. The steering model 71 includes an adder 73, a subtractor 74, an inertia model 75, a first integrator 76, a second integrator 77, and a viscosity model 78.

The adder 73 calculates the input torque Tᵢₙ* by adding the target steering reaction force T₁* and the steering torque Tₕ together. The subtractor 74 calculates a final input torque Tᵢₙ* by subtracting a viscosity component Tᵥᵢ* and a spring component Tₛₚ* described later from the input torque Tᵢₙ* calculated by the adder 73.

The inertia model 75 functions as an inertia control calculation circuit corresponding to the inertia term of Expression (1). The inertia model 75 calculates a steering angle acceleration α* by multiplying together the final input torque Tᵢₙ* calculated by the subtractor 74 and the inverse of the moment of inertia J.

The first integrator 76 calculates a steering angle velocity ω* by integrating the steering angle acceleration α* calculated by the inertia model 75. The second integrator 77 calculates the target steering angle θ* by integrating the steering angle velocity ω* calculated by the first integrator 76. The target steering angle θ* is an ideal rotation angle of the steering wheel 11 (steering shaft 12) that is based on the steering model 71.

The viscosity model 78 functions as a viscosity control calculation circuit corresponding to the viscosity term of Expression (1). The viscosity model 78 calculates the viscosity component Tᵥᵢ* of the input torque Tᵢₙ* by multiplying together the steering angle velocity ω* calculated by the first integrator 76 and the coefficient of viscosity C.

The vehicle model 72 is tuned based on characteristics of the vehicle on which the steering system 10 is mounted. A vehicle-side characteristic that influences the steering characteristic is determined based on, for example, specifications of a suspension and wheel alignment and a grip force (friction force) of each of the steered wheels 16 and 16. The vehicle model 72 functions as a spring characteristic control calculation circuit corresponding to the spring term of Expression (1). The vehicle model 72 calculates the spring component Tₛₚ* (torque) of the input torque Tᵢₙ* by multiplying together the target steering angle θ* calculated by the second integrator 77 and the spring modulus K.

According to the target steering angle calculation circuit 52 having the configuration described above, the relationship between the input torque Tᵢₙ* and the target steering angle θ* can be tuned directly and furthermore a desired steering characteristic can be achieved by adjusting the moment of inertia J and the coefficient of viscosity C of the steering model 71 and the spring modulus K of the vehicle model 72.

The target pinion angle θₚ* is calculated by using the target steering angle θ* calculated from the input torque Tᵢₙ* based on the steering model 71 and the vehicle model 72. Then, feedback control is performed so that the actual pinion angle θₚ equals the target pinion angle θₚ*. As described above, there is a correlation between the pinion angle θₚ and the steered angle θ_{w} of each of the steered wheels 16 and 16. Therefore, the turning operation of each of the steered wheels 16 and 16 that is based on the input torque Tᵢₙ* is also determined by the steering model 71 and the vehicle model 72. That is, the steering feel of the vehicle is determined by the steering model 71 and the vehicle model 72. Thus, a desired steering feel can be achieved by adjusting the steering model 71 and the vehicle model 72.

In the control apparatus 50 having the configuration described above, the steering reaction force (tactile feedback to be acquired through a steering operation) is only based on the target steering angle θ*. That is, the steering reaction force does not change in response to vehicle behavior or a road condition (for example, the possibility of a slip that may occur on a road). Therefore, it is difficult for the driver to grasp the vehicle behavior or the road condition through the steering reaction force. In this embodiment, the vehicle model 72 has the following configuration from the viewpoint of addressing such concerns.

<Vehicle Model>

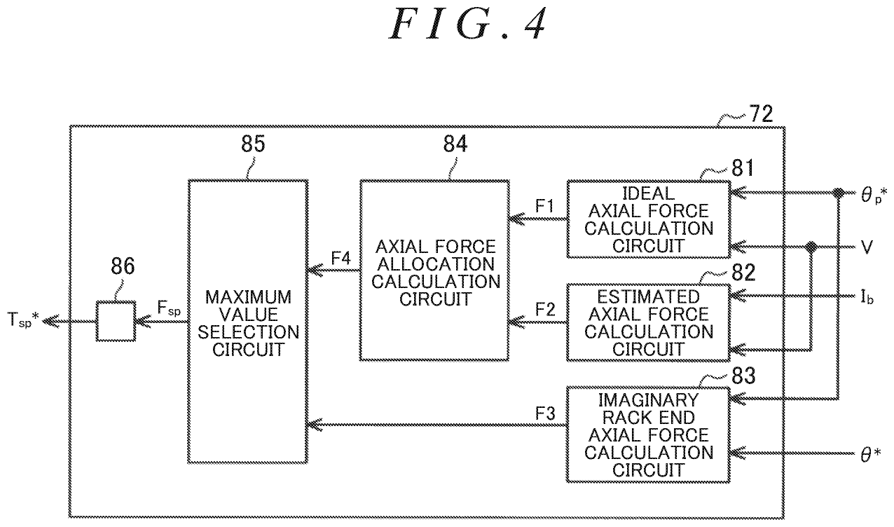

As illustrated in FIG. 4, the vehicle model 72 includes an ideal axial force calculation circuit 81, an estimated axial force calculation circuit 82, an imaginary rack end axial force calculation circuit 83, an axial force allocation calculation circuit 84, a maximum value selection circuit 85, and a conversion circuit 86.

The ideal axial force calculation circuit 81 calculates, based on the target pinion angle θₚ*, an ideal axial force F1 that is an ideal value of an axial force to be applied to the steering operation shaft 14 through the steered wheels 16 and 16. The ideal axial force calculation circuit 81 calculates the ideal axial force F1 by using an ideal axial force map stored in a storage apparatus of the control apparatus 50.

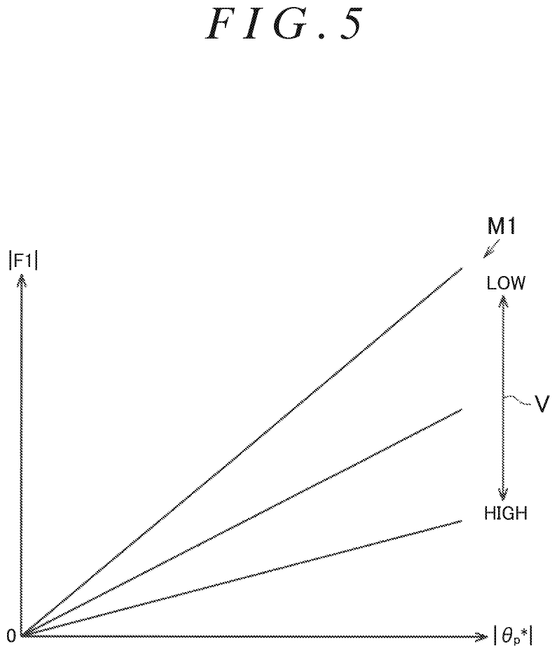

As illustrated in a graph of FIG. 5, an ideal axial force map M1 is a map having a horizontal axis representing the target pinion angle θₚ* and a vertical axis representing the ideal axial force F1. The ideal axial force map M1 defines a relationship between the target pinion angle θₚ* and the ideal axial force F1 depending on the vehicle speed V. The ideal axial force map M1 has the following characteristics. That is, the ideal axial force F1 is set to have a larger absolute value as the absolute value of the target pinion angle θₚ* increases and as the vehicle speed V decreases. The absolute value of the ideal axial force F1 linearly increases relative to the increase in the absolute value of the target pinion angle θₚ*. The ideal axial force F1 is set to have the same sign (positive or negative) as the sign of the target pinion angle θₚ*.

As illustrated in FIG. 4, the estimated axial force calculation circuit 82 calculates an estimated axial force F2 (road reaction force) applied to the steering operation shaft 14 based on the current value I_{b} of the steering operation motor 41. The current value I_{b} of the steering operation motor 41 changes in response to the occurrence of a difference between the target pinion angle θₚ* and the actual pinion angle θₚ due to a situation in which a disturbance caused by a road condition (road frictional resistance) affects the steered wheels 16. That is, the current value I_{b} of the steering operation motor 41 reflects an actual road reaction force applied to the steered wheels 16 and 16. Therefore, an axial force that reflects an influence of the road condition can be calculated based on the current value I_{b} of the steering operation motor 41. The estimated axial force F2 is determined by multiplying the current value I_{b} of the steering operation motor 41 by a gain that is a coefficient based on the vehicle speed V.

The imaginary rack end axial force calculation circuit 83 calculates an imaginary rack end axial force F3 for imaginarily limiting an operation range of the steering wheel 11. The imaginary rack end axial force F3 is calculated from the viewpoint of steeply increasing a torque to be generated by the reaction motor 31 in a direction opposite to a steering direction (steering reaction torque) when the operation position of the steering wheel 11 is close to a limit position of its operation range and when the steering operation shaft 14 is close to a limit position of its physically movable range.

The limit position of the operation range of the steering wheel 11 is determined based on, for example, the length of a spiral cable provided on the steering wheel 11. The limit position of the physical operation range of the steering operation shaft 14 is a position where the movement range of the steering operation shaft 14 is physically limited due to the occurrence of so-called “end abutment”, in which the end of the steering operation shaft 14 (rack end) abuts against the housing (not illustrated).

The imaginary rack end axial force calculation circuit 83 acquires the target steering angle θ* and the target pinion angle θₚ* calculated by the steering angle ratio change control circuit 62 (see FIG. 2). The imaginary rack end axial force calculation circuit 83 compares the target steering angle θ* with the target pinion angle θₚ*, and uses the target steering angle θ* or the target pinion angle θₚ* having a larger absolute value as an imaginary rack end angle for the calculation of the imaginary rack end axial force F3. The imaginary rack end axial force calculation circuit 83 calculates the imaginary rack end axial force F3 by using an imaginary rack end map stored in the storage apparatus of the control apparatus 50.

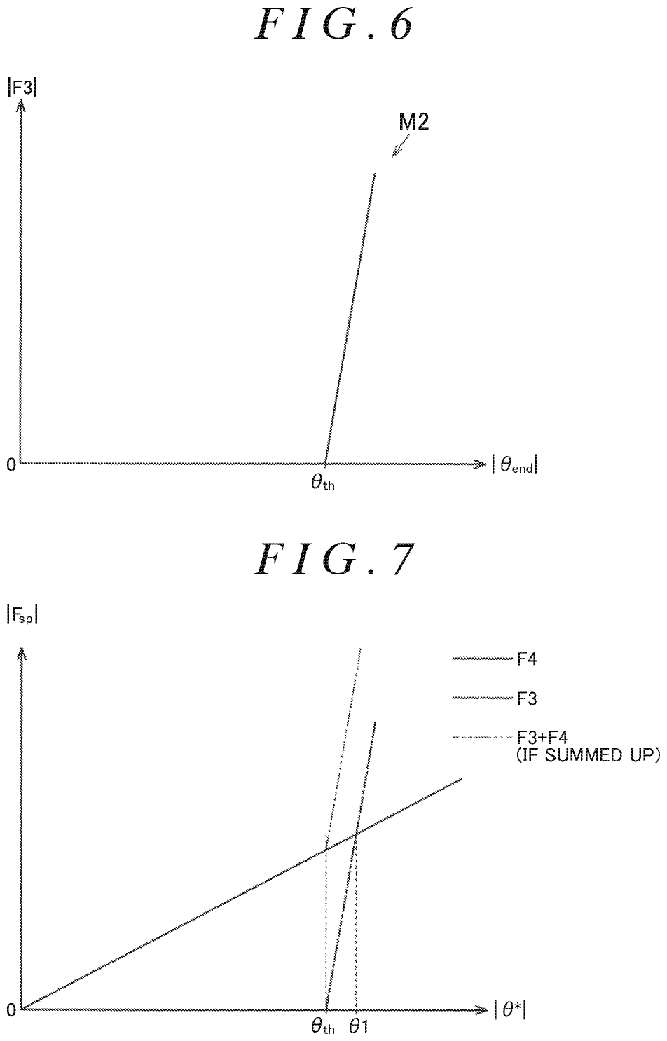

As illustrated in a graph of FIG. 6, an imaginary rack end map M2 is a map having a horizontal axis representing an imaginary rack end angle θ_{end} and a vertical axis representing the imaginary rack end axial force F3. The imaginary rack end map M2 defines a relationship between the imaginary rack end angle θ_{end} and the imaginary rack end axial force F3. The imaginary rack end map M2 has the following characteristics. That is, until the absolute value of the imaginary rack end angle θ_{end} reaches an end determination threshold θₜₕ relative to a reference of “0”, the imaginary rack end axial force F3 is kept at “0” that is a neutral angle corresponding to a neutral steering position or a neutral steered position. After the absolute value of the imaginary rack end angle θ_{end} reaches the end determination threshold θₜₕ, the imaginary rack end axial force F3 is generated, and steeply increases in a direction in which the absolute value of the imaginary rack end axial force F3 increases.

The imaginary rack end axial force F3 is set to have the same sign (positive or negative) as the sign of the imaginary rack end angle θ_{end}. The end determination threshold θₜₕ is set based on a value in the vicinity of the steering angle θₛ when the steering wheel 11 reaches the limit position of the operation range or a value in the vicinity of the pinion angle θₚ when the steering operation shaft 14 reaches the limit position of the movable range.

As illustrated in FIG. 4, the axial force allocation calculation circuit 84 calculates a mixed axial force F4 by summing up a value obtained by multiplying the ideal axial force F1 by an individually set allocation ratio (gain) and a value obtained by multiplying the estimated axial force F2 by an individually set allocation ratio (gain). The allocation ratio is set based on various condition amounts that reflect vehicle behavior, a road condition, or a steering condition. The allocation ratio may be set based only on the vehicle speed V that is one of the condition amounts of the vehicle. In this case, for example, as the vehicle speed V increases, the allocation ratio of the ideal axial force F1 is set to a larger value, and the allocation ratio of the estimated axial force F2 is set to a smaller value. As the vehicle speed V decreases, the allocation ratio of the ideal axial force F1 is set to a smaller value, and the allocation ratio of the estimated axial force F2 is set to a larger value.

The maximum value selection circuit 85 acquires the imaginary rack end axial force F3 calculated by the imaginary rack end axial force calculation circuit 83 and the mixed axial force F4 calculated by the axial force allocation calculation circuit 84. The maximum value selection circuit 85 selects the acquired imaginary rack end axial force F3 or the acquired mixed axial force F4 having a larger absolute value, and sets the selected imaginary rack end axial force F3 or the selected mixed axial force F4 as a final axial force Fₛₚ to be used for calculating the spring component Tₛₚ* for the input torque Tᵢₙ*.

The conversion circuit 86 calculates (by conversion) the spring component Tₛₚ* for the input torque Tᵢₙ* based on the final axial force Fₛₚ set by the maximum value selection circuit 85.

When the maximum value selection circuit 85 sets the mixed axial force F4 as the final axial force Fₛₚ, the spring component Tₛₚ* that is based on the final axial force Fₛₚ is reflected in the input torque Tᵢₙ*. Thus, the steering reaction force can be applied to the steering wheel 11 in response to the vehicle behavior or the road condition. The driver can grasp the vehicle behavior or the road condition by feeling the steering reaction force via the steering wheel 11 as tactile feedback.

When the maximum value selection circuit 85 sets the imaginary rack end axial force F3 as the final axial force Fₛₚ, the spring component Tₛₚ* that is based on the final axial force Fₛₚ is reflected in the input torque Tᵢₙ*. Thus, the steering reaction force steeply increases. Therefore, it is difficult for the driver to operate the steering wheel 11 in a direction in which the absolute value of the steering angle increases. Accordingly, the driver can recognize that the steering wheel 11 reaches the limit position of the imaginary operation range by acquiring a feeling of abutment as the steering reaction force (tactile feedback).

Next, description is given of actions attained by providing the maximum value selection circuit 85 in the vehicle model 72. As a comparative example, description is first given of a case where the vehicle model 72 employs a configuration in which the maximum value selection circuit 85 is not provided and the final axial force Fₛₚ to be used for calculating the spring component Tₛₚ* is calculated by summing up the mixed axial force F4 and the imaginary rack end axial force F3. When this configuration is employed, the following concerns arise.

For example, when the imaginary rack end axial force F3 is calculated because the absolute value of the target steering angle θ* serving as the imaginary rack end angle θ_{end} reaches the end determination threshold θₜₕ, the final axial force Fₛₚ to be used for calculating the spring component Tₛₚ* is calculated by adding the imaginary rack end axial force F3 to the mixed axial force F4 as indicated by a long dashed double-short dashed line in a graph of FIG. 7. Therefore, a final axial force Fₛₚ having an excessive value and furthermore a spring component Tₛₚ* having an excessive value are calculated. Thus, an excessive steering reaction force may be applied to the driver. This phenomenon is likely to occur, for example, when the imaginary rack end axial force F3 is added in a state in which the allocation ratio of the estimated axial force F2 to the mixed axial force F4 is larger, that is, in a state in which the estimated axial force F2 is dominant as in a case where the vehicle turns with a large radius at a low speed. The reason is as follows. The ratio (slope) of an increase in the estimated axial force F2 to an increase in the absolute value of the target steering angle θ* (steering angle θₛ) varies depending on a road condition such as a road frictional resistance. For example, as the road frictional resistance increases and as the steering angle θₛ increases, the estimated axial force F2 has a larger value.

In this respect, the vehicle model 72 of this embodiment is configured such that the imaginary rack end axial force F3 and the mixed axial force F4 are not summed up when the imaginary rack end axial force F3 is calculated. That is, the maximum value selection circuit 85 sets, as the final axial force Fₛₚ, the imaginary rack end axial force F3 or the mixed axial force F4 having a larger absolute value. As illustrated in the graph of FIG. 7, consideration is made to a case where the magnitude relationship between the mixed axial force F4 and the imaginary rack end axial force F3 is reversed across an angle θ1 having an absolute value larger than the absolute value of the end determination threshold θₜₕ (θ1>θₜₕ). In a range between a point where the absolute value of the target steering angle θ* reaches the end determination threshold θₜₕ and a point where the absolute value of the target steering angle θ* reaches the angle θ1 (θ1>θₜₕ), the absolute value of the mixed axial force F4 is larger than the absolute value of the imaginary rack end axial force F3. Therefore, the mixed axial force F4 is set as the final axial force Fₛₚ. After the absolute value of the target steering angle θ* exceeds the angle θ1, the absolute value of the imaginary rack end axial force F3 is larger than the absolute value of the mixed axial force F4. Therefore, the imaginary rack end axial force F3 is set as the final axial force Fₛₚ. Thus, the imaginary rack end axial force F3 is not added to the mixed axial force F4, thereby suppressing the calculation of a final axial force Fₛₚ having an excessive value. Accordingly, the application of an excessive steering reaction force to the driver is suppressed.

According to the first embodiment, the following effects can be attained.

(1) When the imaginary rack end axial force F3 is calculated, the imaginary rack end axial force F3 or the mixed axial force F4 having a larger absolute value is set as the final axial force Fₛₚ to be used for calculating the spring component Tₛₚ* . Since the imaginary rack end axial force F3 is not added to the mixed axial force F4, it is possible to reduce the occurrence of the case where the final axial force Fₛₚ has an excessive value. Thus, it is possible to reduce driver's discomfort due to the application of an excessive steering reaction force to the driver.

In particular, this embodiment is more effective as the ratio of the estimated axial force F2 to the mixed axial force F4 increases and as the value of the estimated axial force F2 increases. The situation in which the imaginary rack end axial force F3 is calculated and the situation in which the ratio of the estimated axial force F2 to the mixed axial force F4 is larger (the estimated axial force F2 is dominant) are equivalent to each other, as typified by the case where the vehicle turns with a large radius at a low speed. When the vehicle model 72 employs the configuration in which the imaginary rack end axial force F3 is added to the mixed axial force F4, the imaginary rack end axial force F3 is added to the mixed axial force F4 having a larger value. Therefore, the value of the final axial force Fₛₚ is likely to increase excessively. In this embodiment, the imaginary rack end axial force F3 is not added to the mixed axial force F4. Therefore, it is possible to reduce the occurrence of the case where the final axial force Fₛₚ has an excessive value.

(2) It is appropriate that the ideal axial force map M1 and the imaginary rack end map M2 be set individually without mutual adjustment. For example, when the imaginary rack end axial force F3 is added to the mixed axial force F4, characteristics of the ideal axial force map M1 and the imaginary rack end map M2 may be adjusted so that the final axial force Fₛₚ does not have an excessive value. In this embodiment, the imaginary rack end axial force F3 or the mixed axial force F4 having a larger absolute value is used as the final axial force Fₛₚ. Therefore, there is no need to perform an operation of adjusting the map characteristics (operation of elaborating the maps) in consideration of the final axial force Fₛₚ. Thus, the operation of setting the ideal axial force map M1 and the imaginary rack end map M2 is simplified.

In this embodiment, the ideal axial force calculation circuit 81 and the estimated axial force calculation circuit 82 constitute a steering range axial force calculation circuit. The steering range axial force calculation circuit is a functional part configured to calculate a steering range axial force based on a condition amount of the vehicle. The steering range axial force is an axial force applied to the steering operation shaft 14 when the steering wheel 11 is operated within an operation range defined as a normally operative steering range. In this embodiment, the ideal axial force F1 and the estimated axial force F2 correspond to the steering range axial force.

The imaginary rack end axial force calculation circuit 83 constitutes a limiting axial force calculation circuit. The limiting axial force calculation circuit is a functional part configured to calculate a limiting axial force as the axial force of the steering operation shaft 14 based on a condition amount of the vehicle in which a steering condition or a steered condition of each of the steered wheels 16 and 16 is reflected. The limiting axial force is an axial force to be calculated in order to imaginarily limit the operation for the steering wheel. In this embodiment, the imaginary rack end axial force F3 corresponds to the limiting axial force.

The imaginary rack end axial force calculation circuit 83 constitutes a range limiting axial force calculation circuit. The range limiting axial force calculation circuit is a functional part configured to calculate a range limiting axial force for limiting the operation range of the steering wheel 11 to an imaginary operation range based on a condition amount that reflects the steering condition or the steered condition of each of the steered wheels 16 and 16. In this embodiment, the imaginary rack end axial force F3 corresponds to the range limiting axial force.

Next, description is given of a steering control apparatus according to a second embodiment, which is applied to the steer-by-wire type steering system. This embodiment provides a configuration basically similar to that of the first embodiment described above with reference to FIG. 1 to FIG. 4.

Depending on, for example, specifications of the steering system 10 or the control apparatus 50, there is a demand that the steering reaction force convey, to the driver, situations other than the situation in which the steering wheel 11 reaches the limit position of the imaginary operation range. Examples of the situation that needs to be conveyed to the driver may include the following two situations (A1) and (A2).

(A1) A situation in which the steered wheels 16 and 16 abut against obstacles such as curbstones when the vehicle starts to travel in a stopped state.

(A2) A situation in which the steered angle θ_{w} of each of the steered wheels 16 and 16 (pinion angle θₚ) cannot follow the target value because a current to be supplied to the steering operation motor 41 and furthermore a torque to be generated by the steering operation motor 41 are limited to values smaller than original values (insufficient) due to, for example, insufficient electric power of an on-board battery.

In this embodiment, the vehicle model 72 employs the following configuration in order that the steering reaction force convey the two situations (A1) and (A2) to the driver.

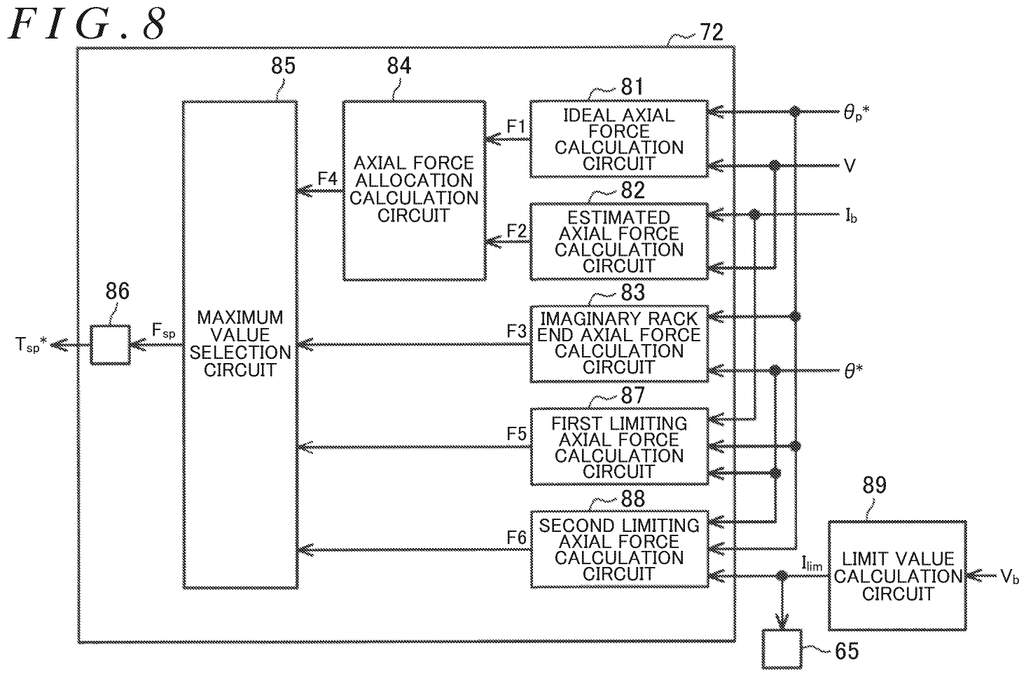

As illustrated in FIG. 8, the vehicle model 72 is provided with a first limiting axial force calculation circuit 87 and a second limiting axial force calculation circuit 88 in addition to the ideal axial force calculation circuit 81, the estimated axial force calculation circuit 82, the imaginary rack end axial force calculation circuit 83, the axial force allocation calculation circuit 84, the maximum value selection circuit 85, and the conversion circuit 86.

The first limiting axial force calculation circuit 87 calculates a first limiting axial force F5 for limiting a further turning operation under the situation in which the steered wheels 16 and 16 abut against obstacles. The first limiting axial force calculation circuit 87 calculates the first limiting axial force F5 based on the current value I_{b} of the steering operation motor 41, the target steering angle θ*, and the target pinion angle θₚ*.

The second limiting axial force calculation circuit 88 calculates a second limiting axial force F6 for limiting a further turning operation under the situation in which the current to be supplied to the steering operation motor 41, that is, the torque to be generated by the steering operation motor 41 is limited to a value smaller than the original value. The second limiting axial force calculation circuit 88 calculates the second limiting axial force F6 based on the target steering angle θ*, the target pinion angle θₚ*, and a limit value Iₗᵢₘ of the current to be supplied to the steering operation motor 41.

The limit value Iₗᵢₘ is calculated by a limit value calculation circuit 89 provided in the control apparatus 50. When a voltage V_{b} of the on-board battery (power supply voltage of the vehicle) reaches a value smaller than a voltage threshold, the limit value calculation circuit 89 calculates a limit value Iₗᵢₘ smaller than a rated current value (original value) of the steering operation motor 41. The limit value calculation circuit 89 calculates a limit value Iₗᵢₘ having a smaller absolute value in response to a decrease in the absolute value of the voltage V_{b}.

The limit value Iₗᵢₘ is also supplied to the energization control circuit 65 of the steering operation control circuit 50b. When the limit value calculation circuit 89 calculates the limit value Iₗᵢₘ, the energization control circuit 65 compares the absolute value of the current to be supplied to the steering operation motor 41 with the limit value Iₗᵢₘ. When the absolute value of the current to be supplied to the steering operation motor 41 is larger than the limit value Iₗᵢₘ, the energization control circuit 65 limits the absolute value of the current to be supplied to the steering operation motor 41 to the limit value Iₗᵢₘ. Thus, the torque to be generated by the steering operation motor 41 is limited to a torque that is based on the limit value Iₗᵢₘ. When the absolute value of the current to be supplied to the steering operation motor 41 is equal to or smaller than the limit value Iₗᵢₘ, the energization control circuit 65 supplies, to the steering operation motor 41, the original current calculated through the feedback control of the current value I_{b}. The torque to be generated by the steering operation motor 41 is not limited, but is kept as the original torque.

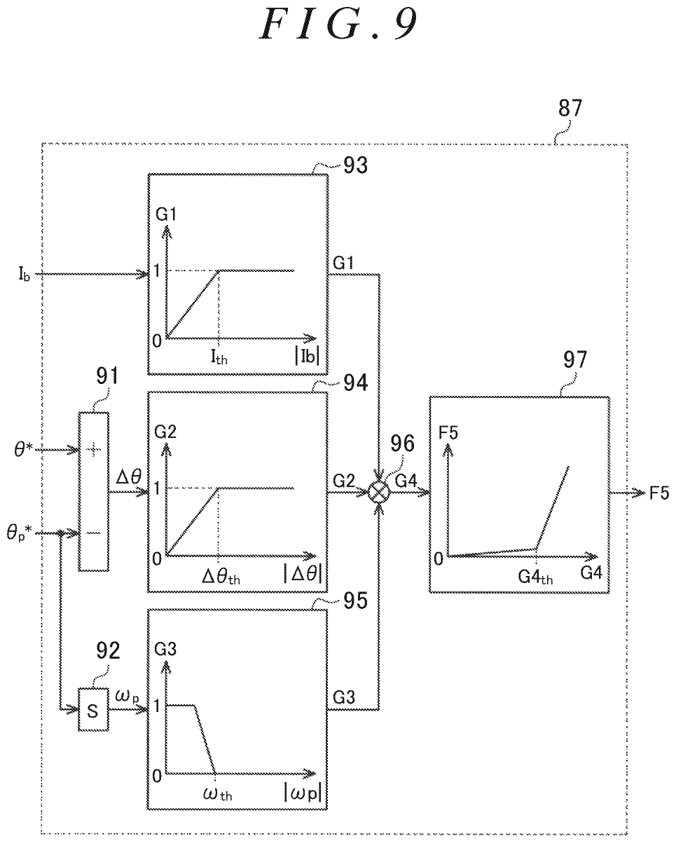

Next, the first limiting axial force calculation circuit 87 is described in detail. As illustrated in FIG. 9, the first limiting axial force calculation circuit 87 includes a subtractor 91, a differentiator 92, a current gain calculation circuit 93, an angle gain calculation circuit 94, a velocity gain calculation circuit 95, a multiplier 96, and an axial force calculation circuit 97.

The subtractor 91 calculates an angular deviation Δθ by subtracting the target pinion angle θₚ* from the target steering angle θ*. The differentiator 92 calculates a pinion angle velocity ωₚ by differentiating the target pinion angle θₚ*.

The current gain calculation circuit 93 calculates a current gain G1 based on the current value I_{b} of the steering operation motor 41. The current gain calculation circuit 93 calculates a current gain G1 having a larger value as the absolute value of the current value I_{b} of the steering operation motor 41 increases from “0”. After the absolute value of the current value I_{b} of the steering operation motor 41 reaches a current threshold Iₜₕ, the current gain calculation circuit 93 sets the value of the current gain G1 to “1” irrespective of the absolute value of the current value I_{b} of the steering operation motor 41. The current threshold Iₜₕ is set through an experiment or simulation based on a current value when the steering operation motor 41 generates a sufficient torque to turn the steered wheels 16 and 16 if the steered wheels 16 and 16 do not abut against obstacles.

The current gain G1 is a value indicating the degree of likelihood of the situation in which the steered wheels 16 and 16 abut against obstacles. That is, the absolute value of the current value I_{b} of the steering operation motor 41 increases as an attempt is made to turn the steered wheels 16 and 16 further in the situation in which the steered wheels 16 and 16 abut against obstacles. Therefore, there is a higher probability that the steered wheels 16 and 16 abut against obstacles as the absolute value of the current value I_{b} of the steering operation motor 41 increases. It is estimated that the steered wheels 16 and 16 abut against obstacles when the current value I_{b} of the steering operation motor 41 is equal to or larger than the current threshold Iₜₕ.

The angle gain calculation circuit 94 calculates an angle gain G2 based on the absolute value of the angular deviation Δθ. The angle gain calculation circuit 94 calculates an angle gain G2 having a larger value as the absolute value of the angular deviation Δθ increases from “0”. After the absolute value of the angular deviation Δθ reaches an angular deviation threshold Δθₜₕ, the angle gain calculation circuit 94 sets the value of the angle gain G2 to “1” irrespective of the absolute value of the angular deviation Δθ.

The angle gain G2 is also a value indicating the degree of likelihood of the situation in which the steered wheels 16 and 16 abut against obstacles. That is, the deviation between the target steering angle θ* and the target pinion angle θₚ* increases as an attempt is made to turn the steered wheels 16 and 16 further in the situation in which the steered wheels 16 and 16 abut against obstacles. Therefore, there is a higher probability that the steered wheels 16 and 16 abut against obstacles as the absolute value of the angular deviation Δθ increases. It is estimated that the steered wheels 16 and 16 abut against obstacles when the angular deviation Δθ is equal to or larger than the angular deviation threshold Δθₜₕ. The angular deviation threshold Δθₜₕ is set through an experiment or simulation in advance in consideration of a tolerance due to, for example, noise of the rotation angle sensors 33 and 43.

The velocity gain calculation circuit 95 calculates a velocity gain G3 based on the absolute value of the pinion angle velocity ωₚ. The velocity gain calculation circuit 95 sets the value of the velocity gain G3 to “1” when the absolute value of the pinion angle velocity ωₚ falls within a range from “0” to a predetermined value. After the absolute value of the pinion angle velocity ωₚ reaches the predetermined value, the velocity gain calculation circuit 95 steeply reduces the value of the velocity gain G3 relative to an increase in the absolute value of the pinion angle velocity ωₚ. After the absolute value of the pinion angle velocity ωₚ reaches a velocity threshold ωₜₕ, the velocity gain calculation circuit 95 sets the value of the velocity gain G3 to “0” irrespective of the absolute value of the pinion angle velocity ωₚ.

The velocity gain G3 is also a value indicating the degree of likelihood of the situation in which the steered wheels 16 and 16 abut against obstacles. That is, it is difficult to turn the steered wheels 16 and 16 under the situation in which the steered wheels 16 and 16 abut against obstacles. Therefore, there is a higher probability that the steered wheels 16 and 16 abut against obstacles as the steered speed of each of the steered wheels 16 and 16 and furthermore the absolute value of the pinion angle velocity ωₚ decrease. It is estimated that the steered wheels 16 and 16 abut against obstacles when the pinion angle velocity ωₚ is equal to or smaller than the predetermined value. The velocity threshold ωₜₕ is set through an experiment or simulation in advance in consideration of a tolerance due to, for example, noise of the rotation angle sensor 43.

The multiplier 96 calculates an obstacle abutment gain G4 by multiplying together the current gain G1 calculated by the current gain calculation circuit 93, the angle gain G2 calculated by the angle gain calculation circuit 94, and the velocity gain G3 calculated by the velocity gain calculation circuit 95. The obstacle abutment gain G4 is a value obtained as a result of comprehensively considering, based on the current value I_{b} of the steering operation motor 41, the angular deviation Δθ, and the pinion angle velocity ωₚ, the degree of likelihood of the situation in which the steered wheels 16 and 16 abut against obstacles.

The axial force calculation circuit 97 calculates the first limiting axial force F5 based on the obstacle abutment gain G4. When the value of the obstacle abutment gain G4 falls within a range from “0” to a gain threshold G4ₜₕ, the axial force calculation circuit 97 gently increases the first limiting axial force F5 relative to an increase in the obstacle abutment gain G4. After the obstacle abutment gain G4 reaches the gain threshold G4ₜₕ, the axial force calculation circuit 97 steeply increases the first limiting axial force F5 relative to the increase in the obstacle abutment gain G4. The gain threshold G4ₜₕ is set through an experiment or simulation in advance as a value at which determination may be made that the steered wheels 16 and 16 abut against obstacles. The first limiting axial force F5 is set from the viewpoint of generating a sufficient steering reaction force to cause difficulty in the driver's turning operation.

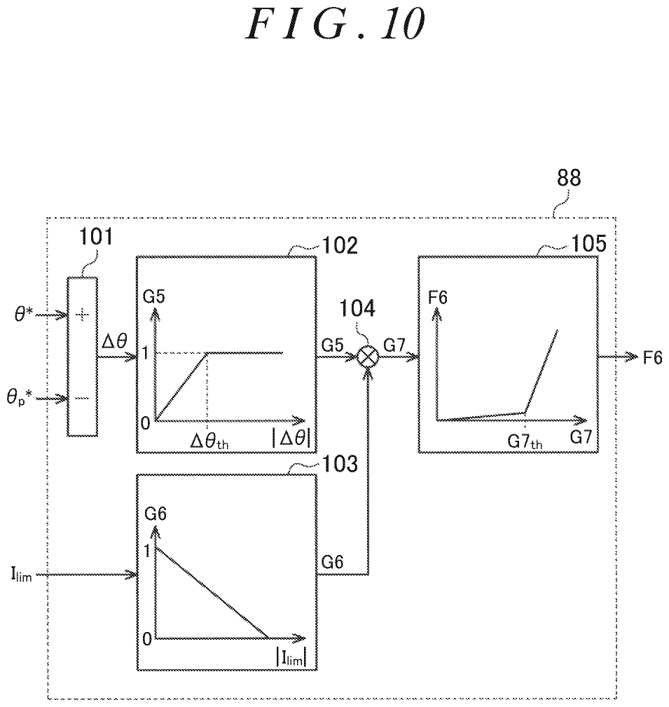

Next, the second limiting axial force calculation circuit 88 is described in detail. As illustrated in FIG. 10, the second limiting axial force calculation circuit 88 includes a subtractor 101, an angle gain calculation circuit 102, a limit value gain calculation circuit 103, a multiplier 104, and an axial force calculation circuit 105.

The subtractor 101 calculates an angular deviation Δθ by subtracting the target pinion angle θₚ* from the target steering angle θ*. The angle gain calculation circuit 102 has a calculation function basically similar to that of the angle gain calculation circuit 94 of the first limiting axial force calculation circuit 87. The angle gain calculation circuit 102 calculates an angle gain G5 based on the absolute value of the angular deviation Δθ. The relationship between the absolute value of the angular deviation Δθ and the angle gain G5 in the angle gain calculation circuit 102 is the same as the relationship between the absolute value of the angular deviation Δθ and the angle gain G2 in the angle gain calculation circuit 94.

The angle gain G5 is a value indicating the degree of likelihood of the situation in which the current to be supplied to the steering operation motor 41 is limited. That is, it is difficult to sufficiently turn the steered wheels 16 and 16 under the situation in which the current to be supplied to the steering operation motor 41 is limited. Therefore, the deviation between the target steering angle θ* and the target pinion angle θₚ* increases as an attempt is made to turn the steered wheels 16 and 16 further. Thus, there is a higher probability of the situation in which the current to be supplied to the steering operation motor 41 is limited as the absolute value of the angular deviation Δθ increases. It is estimated that the current to be supplied to the steering operation motor 41 is limited when the angular deviation Δθ is equal to or larger than an angular deviation threshold Δθₜₕ.

The limit value gain calculation circuit 103 calculates a limit value gain G6 based on the limit value Iₗᵢₘ calculated by the limit value calculation circuit 89. The limit value Iₗᵢₘ is a limit value of the current to be supplied to the steering operation motor 41. The limit value gain calculation circuit 103 calculates a limit value gain G6 having a smaller value as the absolute value of the limit value Iₗᵢₘ increases. The limit value Iₗᵢₘ is a value ranging from “1” to “0”.

The limit value gain G6 is also a value indicating the degree of likelihood of the situation in which the current to be supplied to the steering operation motor 41 is limited. That is, the absolute value of the limit value Iₗᵢₘ is set to a smaller value as the absolute value of the current to be supplied to the steering operation motor 41 is limited to a smaller value. Therefore, there is a higher probability of the situation in which the absolute value of the current to be supplied to the steering operation motor 41 is limited to a smaller value as the absolute value of the limit value Iₗᵢₘ decreases.

The multiplier 104 calculates a steering operation current gain G7 by multiplying together the angle gain G5 calculated by the angle gain calculation circuit 102 and the limit value gain G6 calculated by the limit value gain calculation circuit 103. The steering operation current gain G7 is a value obtained as a result of comprehensively considering, based on the angular deviation Δθ and the limit value Iₗᵢₘ, the degree of likelihood of the situation in which the current to be supplied to the steering operation motor 41 is limited.

The axial force calculation circuit 105 has a calculation function basically similar to that of the axial force calculation circuit 97 of the first limiting axial force calculation circuit 87. The axial force calculation circuit 105 calculates the second limiting axial force F6 based on the steering operation current gain G7. The relationship between the steering operation current gain G7 and the second limiting axial force F6 in the axial force calculation circuit 105 is the same as the relationship between the obstacle abutment gain G4 and the first limiting axial force F5 in the axial force calculation circuit 97. After the steering operation current gain G7 reaches a gain threshold G7ₜₕ, the axial force calculation circuit 105 steeply increases the second limiting axial force F6 relative to an increase in the steering operation current gain G7.

Next, actions of the second embodiment are described. As illustrated in FIG. 8, the maximum value selection circuit 85 acquires the first limiting axial force F5 calculated by the first limiting axial force calculation circuit 87 and the second limiting axial force F6 calculated by the second limiting axial force calculation circuit 88 in addition to the imaginary rack end axial force F3 calculated by the imaginary rack end axial force calculation circuit 83 and the mixed axial force F4 calculated by the axial force allocation calculation circuit 84. The maximum value selection circuit 85 selects an axial force having the largest absolute value among the acquired imaginary rack end axial force F3, the acquired mixed axial force F4, the acquired first limiting axial force F5, and the acquired second limiting axial force F6, and sets the selected axial force as the final axial force Fₛₚ to be used for calculating the spring component Tₛₚ* for the input torque Tᵢₙ*.

The conversion circuit 86 calculates (by conversion) the spring component Tₛₚ* for the input torque Tᵢₙ* based on the final axial force Fₛₚ set by the maximum value selection circuit 85.

When the maximum value selection circuit 85 sets the mixed axial force F4 as the final axial force Fₛₚ, the spring component Tₛₚ* that is based on the final axial force Fₛₚ is reflected in the input torque Tᵢₙ*. Thus, the steering reaction force can be applied to the steering wheel 11 in response to the vehicle behavior or the road condition. The driver can grasp the vehicle behavior or the road condition by feeling the steering reaction force via the steering wheel 11 as tactile feedback.

When the maximum value selection circuit 85 sets the imaginary rack end axial force F3 as the final axial force Fₛₚ, the spring component Tₛₚ* that is based on the final axial force Fₛₚ is reflected in the input torque Tᵢₙ*. Thus, the steering reaction force steeply increases. Therefore, it is difficult for the driver to operate the steering wheel 11 in a direction in which the absolute value of the steering angle θₛ increases. Accordingly, the driver can recognize that the steering wheel 11 reaches the limit position of the imaginary operation range by acquiring a feeling of abutment as the steering reaction force.

When the maximum value selection circuit 85 sets the first limiting axial force F5 as the final axial force Fₛₚ, the spring component Tₛₚ* that is based on the final axial force Fₛₚ is reflected in the input torque Tᵢₙ*. Thus, the steering reaction force steeply increases. Therefore, it is difficult for the driver to operate the steering wheel 11 in a direction in which the absolute value of the steering angle θₛ increases. Accordingly, the driver can recognize the situation in which the steered wheels 16 and 16 abut against obstacles such as curbstones by acquiring a feeling of abutment as the steering reaction force.

When the maximum value selection circuit 85 sets the second limiting axial force F6 as the final axial force Fₛₚ, the spring component Tₛₚ* that is based on the final axial force Fₛₚ is reflected in the input torque Tᵢₙ*. Thus, the steering reaction force steeply increases. Therefore, it is difficult for the driver to operate the steering wheel 11 in a direction in which the absolute value of the steering angle θₛ increases. Accordingly, the driver can recognize the situation in which the current to be supplied to the steering operation motor 41 and furthermore the torque to be generated by the steering operation motor 41 are limited by acquiring a feeling of abutment as the steering reaction force.

According to the second embodiment, the following effects can be attained.

(3) The maximum value selection circuit 85 sets an axial force having the largest absolute value among the imaginary rack end axial force F3, the mixed axial force F4, the first limiting axial force F5, and the second limiting axial force F6 as the final axial force Fₛₚ to be used for calculating the spring component Tₛₚ*. This configuration suppresses the calculation of a final axial force Fₛₚ having an excessive value unlike the case of employing the configuration in which the final axial force Fₛₚ to be used for calculating the spring component Tₛₚ* is obtained by summing up the imaginary rack end axial force F3, the mixed axial force F4, the first limiting axial force F5, and the second limiting axial force F6. That is, the application of an excessive steering reaction force to the driver is suppressed. Thus, it is possible to reduce discomfort due to the application of an excessive steering reaction force to the driver via the steering wheel 11.

In the case of employing the configuration in which the final axial force Fₛₚ to be used for calculating the spring component Tₛₚ* is calculated by adding the imaginary rack end axial force F3, the first limiting axial force F5, and the second limiting axial force F6 to the mixed axial force F4, it is more likely that a final axial force Fₛₚ having an excessive value is calculated. For example, both the imaginary rack end axial force F3 and the first limiting axial force F5 may be added to the mixed axial force F4 when the steered wheels 16 and 16 abut against obstacles such as curbstones in a state in which the absolute value of the target steering angle θ* serving as the imaginary rack end angle θ_{end} reaches a value in the vicinity of the end determination threshold θₜₕ. In this case, the final axial force Fₛₚ is likely to have a larger value.

In this embodiment, the ideal axial force calculation circuit 81 and the estimated axial force calculation circuit 82 constitute the steering range axial force calculation circuit configured to calculate the steering range axial force. In this embodiment, the ideal axial force F1 and the estimated axial force F2 correspond to the steering range axial force.

The imaginary rack end axial force calculation circuit 83, the first limiting axial force calculation circuit 87, and the second limiting axial force calculation circuit 88 constitute the limiting axial force calculation circuit configured to calculate the limiting axial force. In this embodiment, the imaginary rack end axial force F3, the first limiting axial force F5, and the second limiting axial force F6 correspond to the limiting axial force.

The imaginary rack end axial force calculation circuit 83 constitutes the range limiting axial force calculation circuit configured to calculate the range limiting axial force. In this embodiment, the imaginary rack end axial force F3 corresponds to the range limiting axial force.

The first limiting axial force calculation circuit 87 and the second limiting axial force calculation circuit 88 constitute an operation limiting axial force calculation circuit. The operation limiting axial force calculation circuit is a functional part configured to calculate an operation limiting axial force for imaginarily limiting the operation of the steering wheel 11 in the situation in which the steering operation for the steered wheels 16 and 16 is limited. In this embodiment, the first limiting axial force F5 and the second limiting axial force F6 correspond to the operation limiting axial force.

The first and second embodiments may be modified as follows.

In the first and second embodiments, the target steering reaction force calculation circuit 51 determines the target steering reaction force T₁* based on the steering torque Tₕ and the vehicle speed V, but may determine the target steering reaction force T₁* based only on the steering torque Tₕ.

In the first and second embodiments, the target steering angle calculation circuit 52 calculates the target steering angle θ* of the steering wheel 11 by using the input torque Tᵢₙ* that is the sum of the target steering reaction force T₁* and the steering torque Tₕ, but may calculate the target steering angle θ* of the steering wheel 11 by using only the steering torque Tₕ or only the target steering reaction force T₁* as the input torque Tᵢₙ*.

In the first and second embodiments, the control apparatus 50 may employ a configuration in which the differentiation steering control circuit 63 is omitted. In this case, the pinion angle feedback control circuit 64 acquires the target pinion angle θₚ* calculated by the steering angle ratio change control circuit 62, and executes feedback control of the pinion angle θₚ so that the actual pinion angle θₚ follows the acquired target pinion angle θₚ*.

In the first and second embodiments, the control apparatus 50 may employ a configuration in which both the differentiation steering control circuit 63 and the steering angle ratio change control circuit 62 are omitted. In this case, the target steering angle θ* calculated by the target steering angle calculation circuit 52 is directly used as the target pinion angle (θₚ*). That is, the steered wheels 16 and 16 are turned by an amount corresponding to the amount of operation for the steering wheel 11.

In the first and second embodiments, the ideal axial force calculation circuit 81 calculates the ideal axial force F1 based on the target pinion angle θₚ* and the vehicle speed V, but the vehicle speed V need not essentially be taken into consideration when the ideal axial force F1 is calculated. The ideal axial force F1 may be determined by using, in place of the target pinion angle θₚ*, a target steered angle obtained by multiplying the target pinion angle θₚ* by a predetermined conversion coefficient.

In the first and second embodiments, the estimated axial force calculation circuit 82 calculates the estimated axial force F2 based on the current value I_{b} of the steering operation motor 41, but may estimate and calculate an axial force applied to the steering operation shaft 14 based on, for example, a lateral acceleration or a yaw rate detected through an on-board sensor. For example, the estimated axial force may be determined by multiplying the lateral acceleration by a gain that is a coefficient based on the vehicle speed V. The lateral acceleration reflects a road condition such as a road frictional resistance or vehicle behavior, and therefore the estimated axial force calculated based on the lateral acceleration reflects the actual road condition. The estimated axial force may also be determined by multiplying together a yaw rate derivative that is a value obtained by differentiating the yaw rate and a vehicle speed gain that is a coefficient based on the vehicle speed V. The yaw rate also reflects a road condition such as a road frictional resistance or vehicle behavior, and therefore the estimated axial force calculated based on the yaw rate reflects the actual road condition.

In the first and second embodiments, the imaginary rack end axial force calculation circuit 83 may calculate the imaginary rack end axial force F3 by using the steering angle θₛ and the pinion angle θₚ in place of the target steering angle θ* and the target pinion angle θₚ*. In this case, the imaginary rack end axial force calculation circuit 83 uses the steering angle θₛ or the pinion angle θₚ having a larger absolute value as the imaginary rack end angle θ_{end} for the calculation of the imaginary rack end axial force F3.

In the second embodiment, the subtractor 91 of the first limiting axial force calculation circuit 87 and the subtractor 101 of the second limiting axial force calculation circuit 88 calculate the angular deviation Δθ by subtracting the target pinion angle θₚ* from the target steering angle θ*, but may calculate the angular deviation Δθ by subtracting the pinion angle θₚ from the steering angle θₛ. The subtractors 91 and 101 may also calculate the angular deviation Δθ by subtracting, from the target steering angle θ*, a steered angle obtained by multiplying the pinion angle θₚ by a predetermined conversion coefficient.

In the second embodiment, the differentiator 92 of the first limiting axial force calculation circuit 87 calculates the pinion angle velocity ωₚ by differentiating the target pinion angle θₚ*, but may calculate the pinion angle velocity ωₚ by differentiating the pinion angle θₚ.

In the first and second embodiments, the vehicle model 72 may employ a configuration in which the ideal axial force calculation circuit 81 and the axial force allocation calculation circuit 84 are omitted. In this case, the estimated axial force F2 calculated by the estimated axial force calculation circuit 82 is directly used as the final axial force Fₛₚ. In the first embodiment, the vehicle model 72 may employ a configuration in which at least one of the first limiting axial force calculation circuit 87 and the second limiting axial force calculation circuit 88 is provided in place of the imaginary rack end axial force calculation circuit 83. In the second embodiment, the vehicle model 72 may employ a configuration in which the first limiting axial force calculation circuit 87 or the second limiting axial force calculation circuit 88 is omitted.

In the first and second embodiments, the control apparatus 50 calculates the steering reaction force command value T* by adding the steering angle correction amount T₂* to the target steering reaction force T₁*, but may use the steering angle correction amount T₂* as the steering reaction force command value T*. In this case, the control apparatus 50 can employ a configuration in which the adder 55 is omitted. The target steering reaction force T₁* calculated by the target steering reaction force calculation circuit 51 is supplied to the target steering angle calculation circuit 52 alone. The steering angle correction amount T₂* calculated by the steering angle feedback control circuit 54 as the steering reaction force command value T* is supplied to the energization control circuit 56.

In the first and second embodiments, the steering system 10 may be provided with a clutch. In this case, the steering shaft 12 and the pinion shaft 13 are coupled together via a clutch 21 as indicated by long dashed double-short dashed lines in FIG. 1. An electromagnetic clutch is employed as the clutch 21. The electromagnetic clutch connects and disconnects power through connection and disconnection of electric power for an exciting coil. The control apparatus 50 executes engagement/disengagement control for switching engagement and disengagement of the clutch 21. When the clutch 21 is disengaged, power transmission between the steering wheel 11 and each of the steered wheels 16 and 16 is disconnected mechanically. When the clutch 21 is engaged, the power transmission between the steering wheel 11 and each of the steered wheels 16 and 16 is connected mechanically.

The control apparatus 50 of each of the first and second embodiments may be applied to a control apparatus for an electric power steering system (EPS) configured to apply a torque of a motor to the steering mechanism of the vehicle as an assist force. The type of the EPS may be a type in which the assist force is applied to a steering shaft having a pinion shaft that meshes with the steering operation shaft, or a type in which the assist force is applied to the steering operation shaft via a pinion shaft provided independently of the steering shaft. The control apparatus for the EPS controls the motor based on a command value calculated depending on a steering condition. The command value indicates a torque to be generated in the motor. The control apparatus for the EPS may calculate an axial force of the steering operation shaft to be reflected in the command value through execution of feedback control for causing the pinion angle (steered angle) to follow the target pinion angle (target steered angle). The control apparatus for the EPS may also have a function of executing first control for imaginarily limiting the operation range of the steering wheel 11, second control for limiting the turning operation under the situation in which the steered wheels 16 and 16 abut against obstacles such as curbstones, or third control for limiting the turning operation under the situation in which the current to be supplied to the steering operation motor 41 is limited. When at least one of the first control to the third control is executed, there may occur a situation in which an excessive steering reaction force is applied to the steering wheel 11.

What is claimed is:

1. A steering control apparatus configured to control a motor based on a command value calculated depending on a steering condition, the motor being configured to generate a driving force to be applied to a steering mechanism of a vehicle including a steering operation shaft configured to turn a steered wheel, the steering control apparatus comprising:
a steering range axial force calculation circuit configured to calculate a steering range axial force based on a condition amount of the vehicle, the steering range axial force being an axial force applied to the steering operation shaft when a steering wheel is operated within a defined operation range;
a limiting axial force calculation circuit configured to calculate a limiting axial force as an axial force of the steering operation shaft based on a condition amount of the vehicle in which the steering condition or a steered condition of the steered wheel is reflected, so as to imaginarily limit an operation of the steering wheel; and
a selection circuit configured to select an axial force having a largest absolute value out of the steering range axial force and the limiting axial force as an axial force to be reflected in the command value.

2. The steering control apparatus according to claim 1, wherein the limiting axial force calculation circuit includes:
a range limiting axial force calculation circuit configured to calculate a range limiting axial force as the limiting axial force so as to limit the operation range of the steering wheel to an imaginary operation range; and
an operation limiting axial force calculation circuit configured to calculate an operation limiting axial force as the limiting axial force so as to imaginarily limit the operation of the steering wheel in a situation in which a steering operation for the steered wheel is limited.

3. The steering control apparatus according to claim 2, wherein the operation limiting axial force calculation circuit includes a first limiting axial force calculation circuit configured to calculate a first limiting axial force as the limiting axial force so as to imaginarily limit the operation of the steering wheel in a situation in which the steered wheel abuts against an obstacle.

4. The steering control apparatus according to claim 2, wherein
on a premise that the steering mechanism has a structure that achieves separation in power transmission between the steering wheel and the steered wheel or a structure that allows connection and disconnection of the power transmission between the steering wheel and the steered wheel, and that the steering mechanism is provided with a reaction motor serving as the motor and configured to generate, as the driving force, a steering reaction force that is a force to be applied in a direction opposite to an operation direction of the steering wheel, and a steering operation motor serving as the motor and configured to apply, to the steering operation shaft, a steering operation force that is a force for turning the steered wheel,
the operation limiting axial force calculation circuit includes a second limiting axial force calculation circuit configured to calculate a second limiting axial force as the limiting axial force so as to imaginarily limit the operation of the steering wheel in a situation in which a torque of the steering operation motor is limited in comparison with an original torque.

5. The steering control apparatus according to claim 1, wherein the steering range axial force calculation circuit includes an estimated axial force calculation circuit configured to calculate the axial force of the steering operation shaft as an estimated axial force based on a condition amount that reflects a road condition or vehicle behavior.

6. The steering control apparatus according to claim 5, further comprising:
an ideal axial force calculation circuit configured to calculate an ideal axial force based on a target rotation angle of a rotating body configured to rotate in association with the steering operation for the steered wheel, the target rotation angle being calculated depending on the steering condition; and
an allocation calculation circuit configured to calculate a mixed axial force as a final steering range axial force by summing up a value obtained by multiplying the estimated axial force by an allocation ratio and a value obtained by multiplying the ideal axial force by an allocation ratio, the allocation ratios being set individually depending on the condition amount that reflects the vehicle behavior or the road condition or depending on the steering condition.
